(19) United States
(12) Patent Application Publication
(10) Pub. No.: US 2012/0061303 A1
(43) Pub. Date: Mar. 15, 2012

(54) PRECOAT FILTER AND FILTERING ELEMENTS FOR USE IN A FILTER OF THIS TYPE

(75) Inventor: Ulrich Sander, Worms (DE)

(73) Assignee: KHS GmbH, Dortmund (DE)

(21) Appl. No.: 13/318,937

(22) PCT Filed: May 21, 2010
(86) PCT No.: PCT/EP10/03152

§ 371 Date: Nov. 4, 2011

(30) Foreign Application Priority Data
Jul. 7, 2009 (DE) 10 2009 032 201.9

(51) Int. Cl. B01D 37/02

(52) U.S. Cl. 210/193

(57) ABSTRACT

A precoat filter for filtering liquid media or products, in particular for filtering beverages, with at least one partition separating an unfiltered material space and a filtered material space, and with a plurality of filtering elements or candle filters which are arranged on the partition and each project into the unfiltered material space by means of at least one filtering or sieving section having a filtering or sieving structure.

The invention relates to precoat filters according to the preamble of claim 1 and in particular to precoat filters for filtering beverages. The invention also relates to filtering elements or filter candles for use in a filter of this type, according to the preamble of claim 9.

Precoat filters which in each case have a plurality of tubular filtering elements or filter candles, also configured as boiler filters, are known in particular for beverage filtration. The filtering elements, which are rigid in the case of the known precoat filters, are arranged on a partition between an unfiltered material space, to which the liquid medium to be filtered is fed under pressure (up to 9 bar overpressure) together with a filter aid, and a filtered material space for collecting the filtered medium or product (filtrate), so that said filtering elements project into the unfiltered material space with a tubular filtering or sieving section that serves as a support layer for the filter cake which is formed from the filter aid and through which the product to be filtered flows. The maximum dirt holding capacity and thus the maximum service duration of the filter are defined by the spacing between the individual filtering elements. Filter systems are therefore operated in each case only for a predefined service duration. Thereafter, the filter is rinsed in order to remove the accumulated filter aid together with the dirt that is held.

Particularly when an excessively high dosing of the filter aid takes place, for example due to an operating error, a growing-together of the individual filter cakes on the rigid filtering elements may occur, that is to say the filter cake may also form in the space between the filtering elements, before the service duration has elapsed and in a manner unnoticed by the operating staff, namely with the consequence that the effective filter surface area is drastically reduced. As a result, this then leads to an increased loading, in some cases also to an increased loading on one side, on the filtering elements so that the latter are permanently deformed on their filtering or sieving section in particular by bending about axes transverse to the longitudinal axis of the filtering elements, and this deformation leads to an irreversible change, i.e. in particular also an enlargement, of the filter openings or filter gaps. Filtering elements deformed in this way can then not be reused and must be replaced, which leads to high material costs due to the large number of filtering elements used for example in a boiler filter (up to 800 filtering elements per boiler filter) and due to the high price of the filtering elements. Further costs arise as a result of the working effort required for the replacement and as a result of the downtime in production, which may last for several days or weeks.

The problem addressed by the invention is that of providing precoat filters in which such lasting deformation and the resulting unsuitability for use are avoided. In order to solve this problem, precoat filters are configured according to claim 1. Filtering elements for use in a precoat filter form the subject matter of claim 9.

Due to the configuration according to the invention, a lasting deformation and thus unsuitability for use of the filtering elements during normal filter operation and within the respective service duration of a precoat filter are effectively avoided, namely even if one-sided loading of the filtering elements should occur within the normal service duration for example due to an increased dosing of the filter aid. Due to the configuration according to the invention, lateral yielding or deflection of the respective filtering or sieving section is possible, so that the latter is not deformed when subjected to loading from one side and thus also no irreversible changes in the size of the filter openings or filter gaps occur.

Preferably, the filtering elements or filter candles or the deformable sections thereof which have no filter openings or filter gaps are configured to be elastic so that a filtering or sieving section that is moved to the side due to increased loading on one side is moved back into its initial position once this loading ceases.

Further developments, advantages and possible uses of the invention will become apparent from the following description of examples of embodiments and from the figures. All the features described and/or shown, per se or in any combination, in principle form the subject matter of the invention regardless of the way in which they are combined in the claims or of the way in which they refer back to one another. The content of the claims is also incorporated as part of the description.

The invention will be explained in more detail below with reference to the figures and on the basis of an example of embodiment. In the figures:

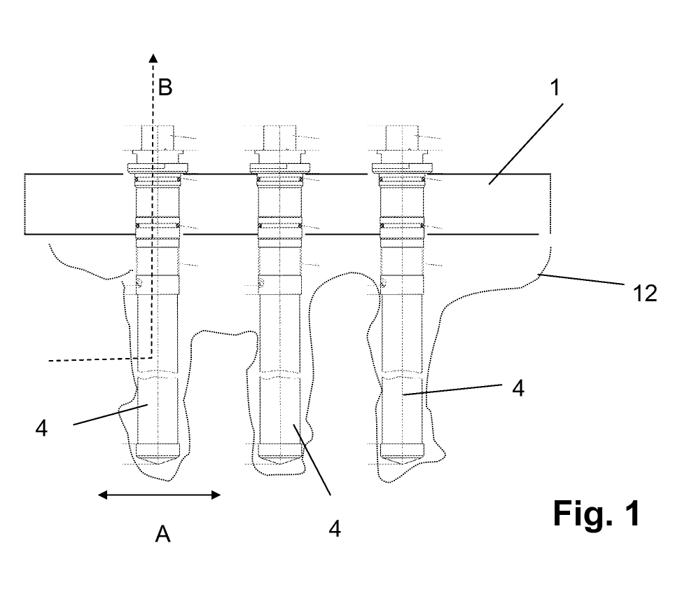

FIG. 1 shows a partial diagram of a supporting wall or partition of a filter vessel of a precoat filter together with three of the filtering elements or filter candles according to the invention provided therein;

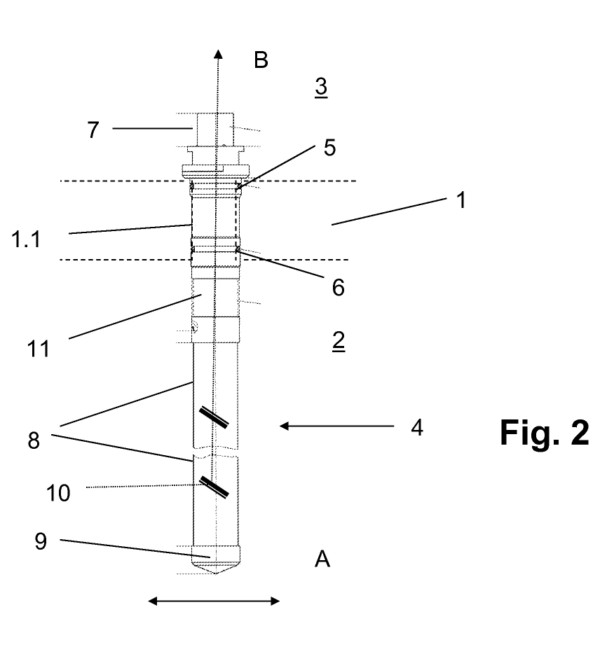

FIG. 2 shows one of the filter candles of FIG. 1 in an enlarged detail view.

In the figures, 1 denotes a supporting wall or partition which divides the interior of a filter vessel, sealed off from the outside and not shown here, into a lower unfiltered material space 2 and an upper filtered material space 3. A plurality of filter candles 4 are provided at a predefined spacing (pitch) on the partition 1, which filter candles are passed through the partition 1 with their axes respectively oriented in a vertical or substantially vertical direction and in a manner sealed off by using ring seals 5 and 6 and project from the partition 1 into the unfiltered material space 2.

As can be seen in particular from FIG. 2, each filter candle consists inter alia of a tubular head piece 7, by means of which the filter candle 4 is locked in the associated opening 1.1 of the partition in a suitably releasable manner and in a manner sealed off by the two ring seals 5 and 6. Each filter candle 4 furthermore has a filtering or sieving section in the form of a split tube 8, which is sealingly closed by a closure piece 9 at its lower end remote from the head piece 7 and has on its outer surface a plurality of filter openings 10 of precisely defined size, for example in the form of a gap having a gap width or a gap size in the range between 10 μm and 100 μm, preferably in the range between approximately 20 μm to 40 μm.

Between the split tube 8 and the head piece 7, the filter candles 4 are each formed with a section which has no filter openings or filter gaps 10 but which has an increased flexibility in comparison to the head piece 7 and the split tube 8. In the illustrated embodiment, this section is formed by a tubular piece or intermediate piece 11 in the form of a finned tube or a bellows, which is sealingly connected to the head piece 7 and to the split tube 8. Within each filter candle 4, therefore, a filter candle interior or channel is formed which is accessible from the unfiltered material space 2 only through the filtering or sieving structure formed by filter openings 10 and which opens into the filtered material space 3 at the upper, open end of the head piece 7.

Due to the intermediate piece 11, a lateral or radial deflection of each filter candle 4 on its section or split tube 8 projecting into the unfiltered material space 2 is possible, as indicated by the double-headed arrow A in FIG. 1. The preferably elastic deformation which is necessary for this deflection takes place exclusively in the intermediate piece 11 which has no filter openings, without this leading to any deformation of the split tube 8.

The filter candles 3 or the components thereof (head piece 7, split tube 8, closure element 9 and intermediate piece 11) are made from a metal material, preferably from stainless steel, for example V4A steel. In principle, however, it is also possible to manufacture the filter candles 4 entirely or at least in sub-regions from plastic. In any case, for the intermediate piece 11, use is preferably made of a material which ensures that the intermediate piece 11 does not experience any lasting deformation when the split tube 8 is subjected to lateral or radial deflection (of course within certain limits), but rather, once the loading has ceased, returns the split tube 8 to the initial position in which the split tube 8 is again coaxial with the head piece 7.

The mode of operation of a precoat filter equipped with the filter candles 4 corresponds to the mode of operation known to the person skilled in the art, in which the unfiltered material is fed to the unfiltered material space 2 under pressure, for example at an overpressure of up to 9 bar, together with an admixed filter aid. Suitable filter aids are in principle the filter aids usually used for the precoat filtration in particular also of beverages, such as e.g. diatomaceous earth, cellulose, polymers, etc. During the respective service duration, the filter aid normally forms a filter cake substantially only around the filter candles 4 projecting into the unfiltered material space 2. Due to the liquid medium to be filtered, which, as indicated by the arrow B, flows from the unfiltered material space 2 through the filter cake, through the filter openings 8 and through the interior of each filter candle 4 until finally reaching the filtered material space 3, a not inconsiderable radial pressure is exerted on each split tube 8, which nevertheless, if the filter cake is formed only around the split tubes 8, leads to a uniform or substantially uniform pressure distribution around the circumference of each split tube 8, so that no one-sided loading occurs.

In the case of an increased admixing of filter aid, this may increasingly fill also the space between the filter candles 4, as indicated by the broken line 12 in FIG. 1, namely in a purely random distribution. This then leads to uncontrolled, in particular also one-sided, increased pressure loads on the filter candles 4, which in the case of a rigid configuration results in an irreversible lasting deformation of the filter candles, namely inter alia with a widening of individual filter openings or filter gaps 10, as indicated by the broken line 10.1 in FIG. 1. However, the maintaining of an exact gap width is vital for the desired filtering effect. Any narrowing of the gap width leads at least to a reduction in filter performance. Any enlargement or widening of the gap width, however, leads to the desired filtering effect being lost.

Due to the intermediate piece 11, a lateral or radial deflection of the split tubes 8 is possible in the case of the filter candles 4 according to the invention, as a result of which there is no risk of lasting deformation of the split tube 8 and of widening of individual filter openings or filter gaps 10.

The configuration of the intermediate piece 11 in the form of a finned tube or a bellows not only allows the lateral, preferably elastic deflection of the filter tube or split tube 8 (double-headed arrow A) but rather, due to the configuration in the form of a finned tube or a bellows, the tubular intermediate piece 11 also has a sufficiently high pressure resistance in spite of its elastic properties, so that it is not deformed under the relatively high pressure at which the filtrate is fed to the unfiltered material space 2 or by the resulting radial forces acting on the outer surface of the intermediate piece 11.

The invention has been described above on the basis of an example of embodiment. It will be understood that numerous changes and modifications are possible. For instance, it has been assumed above that the filtering or sieving section of the filter candles 4 has a plurality of filter openings 10 which are in each case configured as a filter gap. In principle, other configurations are also conceivable, for example in the form that the filtering or sieving section has just one filter gap which surrounds the axis of the filter candle in a number of turns in the manner of a coil, or else a plurality of such filter gaps. In particular, the supporting wall or partition here is just one variant, since register piping (not shown here) can also be used analogously and the described filter candle arrangement or the specific design thereof can likewise be used for this with particular advantage.

### LIST OF REFERENCES

1 supporting wall or partition
1.1 opening
2 unfiltered material space
3 filtered material space
4 filter candle
5, 6 ring seal
7 head piece
8 filter tube or split tube
9 closure piece
10 filter opening or filter gap
11 intermediate piece
12 filter cake
A lateral deflection or deviation of the filter tube or split tube
B flow of the medium to the filtered through the filter candles 4

1-16. (canceled)

17. A manufacture comprising
a precoat filter for filtering liquid, said precoat filter having
a partition separating an unfiltered material space and a filtered material space, and
filtering elements arranged on said partition, each of said filtering elements projecting into said unfiltered material space, and including
a filtering or sieving section, said filtering or sieving section having a filtering or sieving structure, and
a section of increased flexibility between said partition and said filtering or sieving section, said section of increased flexibility allowing deflection of said filtering or sieving section when pressure is applied from one side thereof.

18. The manufacture of claim 17, wherein said filtering elements comprise filter candles.

19. The manufacture of claim 17, wherein said filtering or sieving sections are more rigid than said sections of increased flexibility.

20. The manufacture of claim 17, wherein said sections of increased flexibility lack filtering or sieving structure.

21. The manufacture of claim 17, wherein said filtering or sieving sections comprise filter tubes.

22. The manufacture of claim 17, wherein said filtering or sieving sections comprise split tubes.

23. The manufacture of claim 17, wherein said filtering or sieving structures comprise filter openings.

24. The manufacture of claim 17, wherein said section of increased flexibility comprises an elastically deformable section.

25. The manufacture of claim 17, wherein said filtering elements on said section of increased flexibility comprises a finned tube.

26. The manufacture of claim 17, wherein each of said filtering elements comprises a bellows.

27. The manufacture of claim 17, wherein each of said filtering elements comprises a metal in at least a sub-region thereof.

28. The manufacture of claim 17, wherein said filtering elements comprise a plastic in at least a sub-region thereof.

29. A manufacture comprising
a filtering element for a precoat filter, said filtering element including
a head piece for attachment to a partition separating an unfiltered material space and a filtered material space, said
head piece providing access to an interior of said filtering element, said interior being open at said head piece,
a filtering or sieving section, said filtering or sieving section having a filtering or sieving structure, and
a section of increased flexibility between said partition and said filtering or sieving section, said section of increased flexibility allowing deflection of said filtering or sieving section when pressure is applied from one side thereof.

30. The manufacture of claim 29, wherein said filtering or sieving section is more rigid than said section of increased flexibility.

31. The manufacture of claim 29 wherein said section of increased flexibility lacks filtering or sieving structure.

32. The manufacture claim 29, wherein said filtering or sieving section comprises split tubes.

33. The manufacture of claim 29, wherein said filtering or sieving structure comprises filter openings.

34. The manufacture of claim 29, wherein said filtering element comprises an elastically deformable section.

35. The manufacture of claim 29, wherein said filtering element comprises bellows.

36. The manufacture of claim 29, wherein said filtering element comprises stainless steel in at least a sub-region thereof.
